(19) United States
(12) Patent Application Publication
(10) Pub. No.: US 2006/0204220 A1
(43) Pub. Date: Sep. 14, 2006

(54) Image recording and playing apparatus for automatically generating playlist using bookmark to-video recording format and playlist generating method thereof

(75) Inventor: Sang-min Lee, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co. Ltd., Suwon-si (KR)

(21) Appl. No.: 11/285,114

(22) Filed: Nov. 23, 2005

(30) Foreign Application Priority Data
Mar. 14, 2005 (KR) 2005-20932

(51) Int. Cl. H04N 7/00

(52) U.S. Cl. 386/95

(57) ABSTRACT

An image recording and playing apparatus automatically generating a playlist using a bookmark to—video recording format and playlist generating method thereof in which if a bookmark is designated, a playlist is automatically generated to thereby provide an editing mode. The image recording and playing apparatus includes a recording medium having image data stored thereon; a key input portion for inputting an instruction to designate at least one bookmark into the image data; and a control portion for, if the inputting of the instruction to designate the at least one bookmark through the key input portion is completed, automatically generating a playlist including the at least one designated bookmark, storing the playlist on the recording medium and restoring the playlist on the recording medium if the playlist is edited by providing an editing mode. Accordingly, if a bookmark is designated as an area the user wants to see again, a playlist is automatically generated, and it is possible to modify or delete the designated bookmark from the generated playlist.

### CROSS-REFERENCE TO RELATED APPLICATION

This application claims the benefit of Korean Patent Application No. 2005-20932, filed on Mar. 14, 2005 in the Korean Intellectual Property Office, the disclosure of which is incorporated herein by reference.

### BACKGROUND OF THE INVENTION

1. Field of the Invention

An aspect of the present invention relates to an image recording and playing apparatus and a method for generating a playlist, and more particularly, an aspect of the present invention relates to an image recording and playing apparatus and a method for generating a playlist by designating an area of the recorded contents a user wants to see using a bookmark.

2. Description of the Related Art

The image recording and playing apparatus is one that may record an image data corresponding to an input image signal on a recording medium, play the image data recorded on the recording medium so that a user can watch it and then output the image data to the external display device. Examples of the image recording and playing apparatus includes, a personal video recorder (PVR), a video cassette recorder (VCR), a digital versatile disk (DVD) player, a compact disk (CD) player, a hard disk drive (HDD), a VCD-DVD comb and so on.

When playing the image data recorded on the recording medium, the image recording and playing apparatus can designate the area that a user wants to see again using a bookmark through the user's input. The bookmark allows the specific portion that has been marked to be played at any time the user desires.

In a conventional image recording and playing apparatus, however, the designation of the bookmark by the user's input was made in such a manner that when the image data recorded on the recording medium is played and the area the user wants to see again is displayed, the user designates the bookmark on the area. In this case, the user should designate a starting area of the portion he wants repeated as the bookmark and designate the ending area the portion he wants repeated. Also, the user should store the specified portion and operate the image recording and playing apparatus to generate a playlist. In case the number of portions the user wants to see again is plural, the user should store the designated portion and input external instructions so as to generate the playlist, every time the user designates the bookmark.

Also, when the playlist is required to be displayed, the image recording and playing apparatus displays the generated playlist. Thus, the user can select the bookmark-designated area that he wants from the playlist being displayed.

Accordingly, when the number of portions the user wants to repeat is plural, the user needs to store the designated portion and input external instructions so as to generate the playlist, every time the user designates the bookmark. Therefore, this repetitive process is inconvenient for the user. Further, it is not possible to modify or delete the playlist once recorded because even though the bookmark was mistakenly designated, the playlist cannot be edited.

### SUMMARY OF THE INVENTION

Accordingly, an aspect of the present invention is to provide an image recording and playing apparatus for automatically generating a playlist using bookmark to—video recoding (—VR) format and a playlist generating method thereof in which if a bookmark is designated, a playlist is automatically generated to thereby provide an editing mode.

In order to achieve the above and/or other aspects of the present invention, an image recording and playing apparatus includes a recording medium having image data stored thereon; a key input portion for inputting an instruction to designate at least one bookmark into the image data; and a control portion for, if the inputting of the instruction to designate the at least one bookmark through the key input portion is completed, automatically generating a playlist including the at least one designated bookmark, storing the playlist on the recording medium and then restoring the playlist, which was edited by providing an editing mode of the generated playlist, on the recording medium.

According to another aspect of the present invention, the recording medium is a disk that is rewritable and —VR formatable.

According to another aspect of the present invention, the image recording and playing apparatus further includes a storing portion having the title information of the disk in which the at least one bookmark is designated; a time information which corresponds to the area that the at least bookmark was designated; and a given time to play the above at least one bookmark stored thereon.

According to another aspect of the present invention, the control portion generates a playlist automatically based on the title information of the disk in which the at least one bookmark is designated; a time information which corresponds to the area that the above at least bookmark was designated; and a given time to play the at least one bookmark stored thereon.

According to another aspect of the present invention, the control portion provides an editing screen including respective scenes of the at least one bookmark forming the automatically generated playlist, and preferably performs at least any one of deleting and modifying the above at least one bookmark from the editing screen.

According to another aspect of the present invention, a method for generating a playlist by an image recording and playing apparatus including a recording medium having input image data stored thereon includes storing the image data; designating a least one of bookmark in the image data; and if the designation of the at least one bookmark is completed, automatically generating a playlist including the at least one designated bookmark, storing the playlist on the recording medium and then restoring the playlist, which was edited by providing an editing mode of the above generated playlist, on the recording medium.

According to another aspect of the present invention, the recording medium is a rewritable and —VR formatable disk.

According to another aspect of the present invention, the above method further includes storing the title information of the disk in which the at least one bookmark is designated; a time information which corresponds to the area that the above at least bookmark was designated; and a given time to play the above at least one bookmark.

According to another aspect of the present invention, the playlist is generated based on the title information of the disk in which the at least one bookmark is designated; a time information which corresponds to the area that the at least bookmark was designated; and a given time to play the at least one bookmark.

According to another aspect of the present invention, it is possible to provide an editing screen including respective scenes of the at least one bookmark constructing the automatically generated playlist, and performing at least any one of deleting and modifying the at least one bookmark from the above editing screen.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 shows a block diagram of an image recording and playing apparatus according to an embodiment of the present invention;

FIG. 2 shows one example of a bookmark according to an embodiment of the present invention;

FIG. 3 shows a screen for editing a playlist in an image recording and playing apparatus according to an embodiment of the present invention; and

FIG. 4 shows a flow chart illustrating a method for generating a playlist in accordance with an image recording and playing apparatus according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

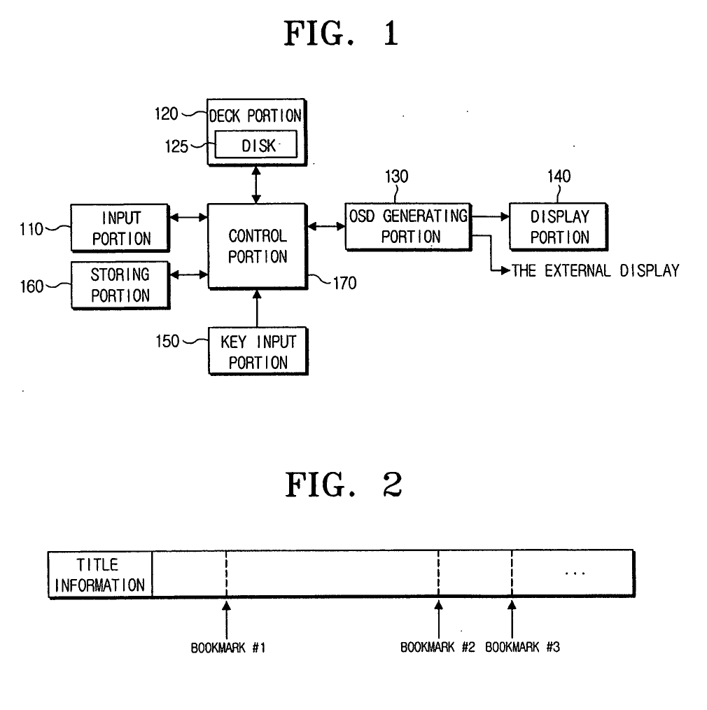

FIG. 1 shows a block diagram of an image recording and playing apparatus according to one embodiment of the present invention.

With reference to FIG. 1, the image recording and playing apparatus according to an aspect of the present invention includes an input portion 110, a deck portion 120, an OSD generating portion 130, a display portion 140, a key input portion 150, a storing portion 160 and a control portion 170.

The input portion 110 is connected to external devices such as a television and so on and receives image signals from the external devices.

The deck portion 120 includes a disk 125 and records image data corresponding to the image signals inputted from the external devices on the disk 125. The deck portion 120 reads the image data recorded on the disk 125. Also, the deck portion 120 records a bookmark designated in the image data by a user as well as a playlist generated automatically by the OSD generation portion 130, on the disk 125.

The disk 125, which is installed on the deck portion 120 and which is a recording medium for recording thereon an image data inputted through the input portion 110 from the external devices, is able to provide a —Video Recording (—VR) format. The —VR format is a format allowing the content recorded on a re-writable disk to be edited.

The OSD generating portion 130 generates a user's bookmark designation, a playlist generation and a menu for editing the playlist in the OSD image, and outputs them through a display portion 140 or the input portion 110 to external devices such as a television and so on.

The display portion 140, which is a display installed on the image recording and playing apparatus, displays the image data recording state on the disk by the deck portion 120, the playing state thereof and so on. The display portion 140 also displays the designation of the bookmark generated by the OSD generating portion 130 as well as a menu for editing a playlist.

An external display, which is installed on such external devices such as a television and so on, displays image data read from the disk 125 by the deck portion 120. Further, the external display displays the designation of the bookmark generated by the OSD generating portion 130, a menu for editing a playlist and a playlist.

The key input portion 150 for inputting a user's external instruction includes a key for designating the user's bookmark, a key for generating a playlist when the designation of the bookmark is completed, and directional and selection keys for editing the playlist. The user can designate a bookmark that he wants to see again using the bookmark designating key while viewing the image data recorded on the disk 125 which are displayed on the external display by the deck portion 120. When the designation of the bookmark has been completed, the user can generate an area, in which the bookmark was designated, as a playlist by using the playlist generating key installed on the key input portion 150. When the playlist is generated, the user can edit the generated playlist using the directional and selection keys installed on the key input portion 150.

The storing portion 160 stores a control program for controlling the operation of the image recording and playing apparatus. The storing portion 160 stores a given time for defining the interval from the starting portion having the bookmark designated to the ending portion in which playing should be completed. As one example, if the given time is defined five minutes, the deck portion 120 starts playing the image data from the starting portion in which the user has designated the bookmark and stops playing the image data after five minutes therefrom.

Also, the storing portion 160 stores temporarily the title information currently recorded on the disk 125 in the deck portion 120 as well as the time information of the bookmark area designated by the user. The control portion 170 generates a playlist automatically using the bookmark in —VR format and controls the image recording and playing apparatus to edit the generated playlist.

More specifically, the control portion 170 controls the deck portion 120 to read the image data recorded on the disk 125 and displays the data to the external display. If the user requests a menu to designate a bookmark using the key input portion 150 among displays of the image data, the control portion 170 controls the OSD generating portion 130 to generate a menu for designating the bookmark and to output the menu to the external display.

If the user designates the bookmark using the key input portion 150, the control portion 170 temporarily stores on the storing portion 160 the title information of disk 125 currently displayed as well as the time information of the bookmark area designated by the user.

Then, if the designation of the bookmark by the user has been completed and the user requests a menu for generating the playlist using the key input portion 150, the control portion 170 controls the OSD generating portion 130 to generate a menu for generating the playlist and to output it to the external display.

If the user selects an automatic generation of the playlist using the key input portion 150, the control portion 170 generates the playlist based on the title information of the disk 125, the time information of the bookmark area and a given time for defining the interval from the starting portion having the bookmark designated to the ending portion in which a playing should be completed. Further, the control portion 170 controls the deck portion 120 and records the generated playlist on the disk 125.

Also, if the user requests a menu for editing the playlist using the key input portion 150, the control portion 170 controls the OSD generating portion 130 to generate the menu for editing the playlist and outputs the menu to the external display. The control portion 170 provides a menu for deleting the bookmark listed in the playlist, controlling the defined given time and so on.

If the user requests to delete any one of bookmarks listed on the playlist displayed on the external display using the key input portion 150, the control portion 170 deletes the requested bookmark. If the user adjusts the time interval of any one of the bookmarks listed on the playlist displayed on the external display using the key input portion 150, the control portion 170 allows the selected bookmark to have the adjusted time interval. When the editing has been completed, the control portion 170 controls the deck portion 120 to rewrite the edited playlist on the disk 125.

FIG. 2 shows one example of a bookmark. With reference to FIG. 2, there are shown bookmarks #1, #2 and #3, etc, on the title information of image data and the specific position designated by the user's selection.

The title information includes the ID of the disk 125, the title of image data and so on. The user designates a bookmark on an area that he wants to see again when the image data is displayed using a designating key in the key input portion 150. The control portion 170 temporarily stores the title information of the image data as well as the bookmark designated by the user on the storing portion 160.

Table 1 shows a playlist generated automatically. As shown in FIG. 2, if the user designates a bookmark and applies an instruction to generate a playlist, the control portion 170 generates a playlist corresponding to the designated bookmark as shown in Table 1.

TABLE 1

| ID of disk | Bookmark | Starting time | Ending time |
|---|---|---|---|
| Disk | Bookmark #1 | 00:15:00 | 00:20:00 |
| #1 | Bookmark #2 | 00:33:00 | 00:38:00 |
| | Bookmark #3 | 00:59:26 | 01:04:26 |
| | . | . | . |
| | . | . | . |
| | . | . | . |

With reference to Table 1, the generated playlist includes an ID of disk 125, a starting time of the designated bookmark and an ending time thereof. If the starting time when the image data recorded on the disk #1 by the deck portion 120 is set to 00:00:00, the bookmark #1 is designated as the area lapsed fifteen minutes after the image data started playing. The ending time of the bookmark #1 is set to a given time which is an ending interval stored on the storing portion 160. Herein, the given time recorded on the storing portion 160 is five minutes and the ending time of the bookmark #1 is twenty minutes lapsed five minutes after the designated starting time.

The control portion 170 automatically calculates the ending time of the bookmark in accordance with the given time stored on the storing portion 160 based on the time point that the user designated the bookmark, thereby avoiding any inconvenience that otherwise, the user should designate the ending time of the bookmark.

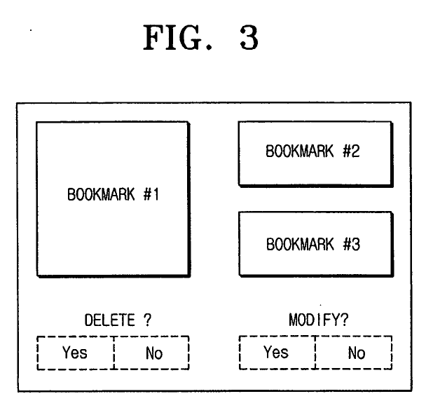

FIG. 3 shows a screen for editing a playlist in the image recording and playing apparatus according to one embodiment of the present invention.

As shown in FIG. 3, the playlist in Table 1 can be displayed as a scene when the bookmark was designated, that is the respective scene at the time when the bookmarks #1, #2 and #3 were designated. More particularly, if the user requests a menu for editing the playlist using the key input portion 150 and selects a playlist editing mode, the control portion 170 displays on the external display an editing screen including respective scenes at the time when respective bookmarks forming the playlist were designated. The editing mode allows modification or deletion of the bookmark forming part of the generated playlist and provides an editing screen including respective scenes at the time when respective bookmarks forming the playlist were designated.

Accordingly, by viewing respective scenes displayed on the editing screen, the user can see that content of image data in the area designated by the respective bookmarks. If the user selects a scene among the respective scenes displayed on the editing screen, the selected scene becomes a main screen. Herein, it is possible for the user to play the bookmark selected on the editing screen as well as to delete the bookmark. Further, although the ending time the of the bookmark is set to five minutes in accordance with a given time stored on the storing portion 160, the user can adjust the ending time as he wants.

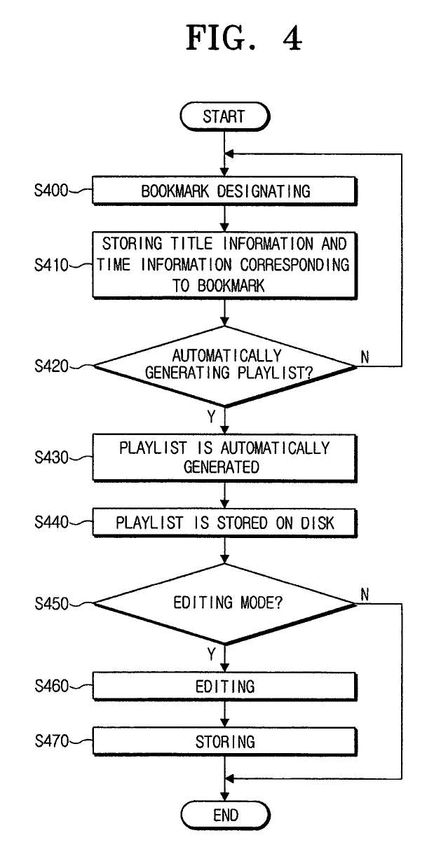

FIG. 4 shows a flow chart illustrating a method of generating a playlist in accordance with an image recording and playing apparatus according to an embodiment of the present invention.

With reference to FIG. 4, the user designates a bookmark on the area he wants to see again using a bookmark designating key in the key input portion 150 (S400). More specifically, if the deck portion 120 displays the image data recorded on the disk 125 to the external display in accordance with the control portion 170, the user can designate a bookmark on the area he wants to see again while viewing the image data, using the bookmark designating key in the key input portion 150.

The control portion 170 temporarily stores on the storing portion 160 the title information of disk 125 currently displayed as well as the time information of the bookmark area designated by the user (S410).

When the designation of the bookmark has been completed, the control portion 170 determines as to whether or not a playlist should be generated automatically (S420). When the designation of the bookmark has been completed, the user inputs an instruction to generate automatically the playlist based on the designated bookmark using the bookmark generating key in the key input portion 150.

If the instruction to automatically generate the playlist was inputted, the control portion 170 generates automatically the playlist (S430). In more detail, the control portion 170 generates the playlist based on the title information of the disk 125, the time information of the bookmark area and a given time for defining the interval from the starting portion having the bookmark designated to the ending portion in which a playing should be completed. The control portion 170 stores the generated playlist on the disk 125 (S440). The control portion 170 determines whether or not to select the editing mode (S450). The editing mode is a mode for providing modification and deletion of the bookmark constructing the generated playlist. When the playlist is generated, the user can select the playlist editing mode using directional and selection keys used to edit the playlist in the key input portion 150.

If the playlist editing mode is selected, the user edits the playlist (S460). The user may delete the bookmark included in the playlist or modify the playing time of the bookmark by using direction keys and selection keys for editing the playlist included in the key input portion 150.

When edits to the playlist have been completed, the control portion 170 re-stores on the disk 125 the edited playlist using —VR format (S470). The —VR format is called as the format for allowing the content recorded on a re-writable disk 125 to be edited and to be re-writeable.

In the foregoing, it was described in detail regarding that when the designation of a bookmark has been completed, the user applies an instruction for generating a playlist in order to generate the playlist. However, the above description is only one embodiment and it is also possible that the control portion monitors the completed time point of bookmark designation or the completed time point of image data playing time and thereby automatically generates a playlist.

The key input portion 150 for inputting a user's external instruction includes a key for designating the user's bookmark, a key for generating a playlist when the designation of the bookmark is completed, and directional and selection keys for editing the playlist. The user can designate a bookmark that he wants to see again using the bookmark designating key while viewing the image data recorded on the disk 125 which is displayed on the external display by the deck portion 120. When the designation of the bookmark has been completed, the user can generate the area, in which the bookmark was designated, as a playlist by using the playlist generating key installed on the key input portion. When the playlist is generated, the user can edit the generated playlist using the directional and selection keys installed on the key input portion 150.

As described above, if a bookmark is designated in the area that user wants to see again, a playlist is automatically generated, and it is possible to modify or delete the designated bookmark from the generated playlist.

According to another aspect of the present invention, there is provided a computer readable medium encoded with processing instructions for performing a method of generating a playlist through an image recording and playing apparatus including a recording medium having image data stored thereon, the method comprising: storing the image data; designating at least one bookmark in the image data; and if the designation of the at least one bookmark is completed, automatically generating a playlist including the at least one designated bookmark and storing the playlist on the recording medium, and if the playlist is edited by providing an editing mode, storing the edited playlist on the recording medium.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An image recording and playing apparatus comprising:
a recording medium having image data stored thereon;
a key input portion for inputting an instruction to designate at least one bookmark into the image data; and
a control portion automatically generating a playlist including the at least one designated bookmark and storing the playlist on the recording medium if the inputting of the instruction to designate the at least one bookmark through the key input portion is completed, and
storing the playlist on the recording medium if the playlist is edited by providing an editing mode of the generated playlist.

2. The image recording and playing apparatus according to claim 1, wherein the recording medium is a rewritable and —VR formatable disk.

3. The image recording and playing apparatus according to claim 2, further comprising a storing portion having title information of the disk in which the at least one bookmark is designated, time information which corresponds to an area that the at least one bookmark was designated, and a given time to play the at least one bookmark stored thereon.

4. The image recording and playing apparatus according to claim 3, wherein the control portion generates the playlist automatically based on the title information of the disk in which the at least one bookmark is designated; the time information which corresponds to the area that the at least one bookmark was designated; and the given time to play the at least one bookmark stored thereon.

5. The image recording and playing apparatus according to claim 1, wherein the control portion provides an editing screen including respective scenes of the at least one bookmark forming the automatically generated playlist, and allowing at least any one of deleting and modifying the at least one bookmark.

6. A method of generating a playlist through an image recording and playing apparatus including a recording medium having image data stored thereon, the method comprising:
storing the image data;
designating at least one bookmark in the image data; and
if the designation of the at least one bookmark is completed, automatically generating a playlist including the at least one designated bookmark and storing the playlist on the recording medium, and
if the playlist is edited by providing an editing mode, storing the edited playlist on the recording medium.

7. The method of generating a playlist according to claim 6, wherein the recording medium is a rewritable and —VR formatable disk.

8. The method of generating a playlist according to claim 7, further comprising storing title information of the disk in which the at least one bookmark is designated, time information which corresponds to an area where the at least one bookmark was designated, and a given time to play the at least one bookmark.

9. The method of generating a playlist according to claim 8, wherein the playlist is generated based on the title information of the disk in which the at least one bookmark is designated, the time information which corresponds to an area where the at least one bookmark was designated, and the given time to play the at least one bookmark.

10. The method of generating a playlist according to claim 6, wherein an editing screen is provided, the editing screen including respective scenes of the at least one bookmark forming the automatically generated playlist, and allowing at least any one of deleting and modifying the at least one bookmark.

11. The image recording and playing apparatus according to claim 1, further comprising an OSD generating portion generating the at least one bookmark, the playlist and a menu for editing the playlist.

12. The image recording and playing apparatus according to claim 11, further comprising a deck portion reading the image data recorded on the recording medium, and recording the at least one bookmark and the playlist on the recording medium.

13. The image recording and playing apparatus according to claim 12, wherein the control portion controls the deck portion to read the image data recorded on the recording medium and displays the image data on an external display.

14. The image recording and playing apparatus according to claim 1, wherein if a user requests a menu for editing the playlist using the key input portion and selects a playlist editing mode, the control portion displays on an external display an editing screen including respective scenes at a time when respective bookmarks forming the playlist were designated.

15. The image recording and playing apparatus according to claim 3, wherein if a user designates the at least one bookmark using the key input portion, the control portion temporarily stores on the storing portion the title information of the disk currently being displayed as well as the time information of the at least one bookmark area designated by the user.

16. The image recording and playing apparatus according to claim 1, wherein by using direction keys and selection keys included in the key input portion a user deletes the at least one bookmark included in the playlist or modifies a playing time of the at least one bookmark.

17. The image recording and playing apparatus according to claim 1, wherein the control portion generates a playlist automatically using the at least one bookmark in —VR format and controls the image recording and playing apparatus to edit the generated playlist.

18. The method of generating a playlist according to claim 10, wherein when edits to the playlist are complete, the edited playlist is stored on the recording medium using —VR format.

19. A method of generating a playlist through an image recording and playing apparatus including a recording medium having image data stored thereon, the method comprising:
designating image data playing time;
determining whether a playlist is automatically generated when the image data playing time has been completed; and
if the designation of the image data playing time is completed, automatically generating a playlist including the image data playing time and storing the playlist on the recording medium, and
if the playlist is edited by providing an editing mode of the generated playlist storing the edited playlist on the recording medium.

20. The method of generating a playlist according to claim 19, wherein the recording medium is a rewritable and —VR formatable disk.

21. The method of generating a playlist according to claim 19, wherein when edits to the playlist are complete, the edited playlist is stored on the recording medium using —VR format.
